(19) United States
(12) Patent Application Publication
(10) Pub. No.: US 2021/0244004 A1
(43) Pub. Date: Aug. 12, 2021

(54) APPARATUS FOR INJURING OR KILLING UNDESIRED ORGANISMS IN WATER

(71) Applicant: Askvik Aqua AS, Hjelmeland (NO)

(72) Inventor: Rune Eritzland, Stavanger (NO)

(73) Assignee: Askvik Aqua AS, Hjelmeland (NO)

(21) Appl. No.: 16/973,278

(22) PCT Filed: Jun. 13, 2019
(86) PCT No.: PCT/NO2019/050123

§ 371 Date: Dec. 8, 2020

(30) Foreign Application Priority Data
Jun. 14, 2018 (NO) 20180828

(51) Int. Cl. A01K 61/13; C02F 1/46; C02F 1/461; A01M 1/22

(52) U.S. Cl. CPC A01K 61/13; C02F 1/4608; C02F 1/46109; C02F 2303/14; C02F 2001/46152; C02F 2201/4613; C02F 2201/46175; A01M 1/22

(57) ABSTRACT

An apparatus is for injuring or killing undesired organisms in water in a channel. The apparatus has an insert which is arranged to be releasably attached to the channel on the inside of the channel, a plurality of electrodes that are attached to the insert, the insert being formed from an electrically insulating material and the plurality of electrodes being connected to a power-supply unit. A method for using the apparatus in the channel is described as well.

### CROSS-REFERENCE TO RELATED APPLICATIONS

This application is the U.S. national stage application of International Application PCT/NO2019/050123, filed Jun. 13, 2019, which international application was published on Dec. 19, 2019, as International Publication WO 2019/240595 in the English language. The International Application claims priority of Norwegian Patent Application No. 20180828, filed Jun. 14, 2018. The international application and Norwegian application are both incorporated herein by reference, in entirety.

### FIELD

The invention relates to an apparatus for injuring or killing undesired organisms in water. More particularly, the invention relates to an apparatus comprising an insert which may be put into a pipe or a channel and be taken out again from the pipe or channel. The water, which may contain the undesired organisms, flows through the pipe or channel and past the apparatus. The invention further relates to the apparatus being arranged to be positioned internally in a pipe or in a channel that supplies a closed farming facility with water, especially sea water, from a depth below the farming facility. The undesired organisms may especially comprise eggs and pelagic larvae of salmon lice. The apparatus is provided with a plurality of elongated electrodes. The electrodes are supplied with power from a power-supply unit so that an electric field is formed inside the pipe or channel. The electric field is of such a quality that the undesired organisms are killed or at least get so much injury inflicted on them that the organisms are no longer infectious after having passed the electric field.

### BACKGROUND

Fish-farming in closed enclosures involves keeping a large number of fish together in a small area. This gives good conditions for parasites. In salmonid farming, external crustacean parasites have become a problem. Especially salmon lice (Lepeophtheirus salmonis) are present in large numbers. It is necessary to treat fish that are infected with salmon lice, to keep the amount of parasites down and to safeguard the welfare of the fish.

So-called closed facilities or closed cages have been developed for the farming of fish. By a closed facility is meant that the enclosure for fish comprises a liquid-tight wall and bottom. The wall may be formed from a rigid material such as a hard plastic, concrete or a metal. The wall may also be formed from a soft material such as a plastic sheet. The water inside the enclosure is changed by water being pumped in and by water being carried out through openings in the bottom or in the wall. The openings are secured so that fish cannot escape through the openings. The water that is pumped in may be taken through a pipe from a desired depth, and the depth may be varied. The pump sits inside the pipe.

The first stages of salmon lice are pelagic larvae. After hatching, the salmon-louse larva goes through two nauplius stages and the copepodid stage. The copepodid stage is the infectious stage that attaches to the host. The pelagic salmon lice have a limited ability to swim, but they are phototactic so that they stay in the upper part of the water column. One of the advantages of a closed facility is that the facility has the possibility of having a water inlet so deep that eggs and salmon-louse larvae will not get into the enclosure via the supply water. However, experience has proved that in some cases, salmon-louse larvae are entrained in the supply water even if the inlet is placed at a depth of 20 metres and even at a depth of 30 metres.

Salmon lice that have come into a closed facility will multiply and give the same problems of salmon-louse infection as in an open facility.

Patent document EP2837284 discloses the use of an electric field to remove salmon lice from fish. The fish is guided through a chamber provided with electrodes called “reflectors”. The patent document is silent about to the shape of the electrodes and how the electrodes are attached to the chamber.

It is known that an electric field between submerged electrodes may kill salmon lice. The electric field must have a quality that kills salmon lice and eggs. By quality is meant that there must be a sufficient difference in voltage between the electrodes, and the electric field must have sufficient strength. It is known that it is advantageous to use direct current which switches between being on an off, so-called pulses, and that the electrodes may alternate in polarity. That is to say, a positive electrode will be a negative electrode at the next electric pulse.

Sea water is an electrolyte. It is well known that electrodes in sea water corrode away and must be replaced. The time it takes is dependent on, inter alia, the voltage and the amperage. Electrodes made of titanium have relatively good resistance to corrosion, but even electrodes made of titanium will corrode away.

Water that is to be treated with an electric field may be passed through an electric field in a pipe or in a channel. In what follows, a channel will also comprise a pipe. It is technically obvious that such a channel must be formed from a non-conductive material. A channel made of metal will conduct electricity and the current will travel into an entire facility if a channel made of metal is connected to a pipe system made of metal. This will lead to extensive corrosion damage in the entire facility. Polyethene (PE) is an example of a suitable plastic material for such a channel.

It is relatively large amounts of water that must be treated per time unit, and the channel must be dimensioned accordingly. For example, the channel may have an inner diameter of 80 cm. A voltage of between 12 and 200 V combined with amperage of between 50 A and 500 A may be necessary to achieve the desired quality of the electric field.

The person skilled in the art is thus faced with a problem in using electricity to ensure that pelagic salmon-louse larvae and salmon-louse eggs in supply water are killed or rendered harmless before the water is carried into a closed farming facility. Replacing the electrodes is part of the problem.

### SUMMARY

The invention has for its object to remedy or to reduce at least one of the drawbacks of the prior art or at least provide a useful alternative to the prior art.

The object is achieved through the features that are specified in the description below and in the claims that follow.

In a first aspect, the invention relates, more specifically, to an apparatus for injuring or killing undesired organisms in water in a channel, wherein the apparatus comprises an insert which is arranged to be releasably attached to the channel on the inside of the channel, a plurality of electrodes are attached to the insert, the insert is formed from an electrically insulating material and the plurality of electrodes are connected to a power-supply unit.

The cannel may be formed from an electrically insulating material. The insert may be elongated with a first longitudinal axis, and the electrode may be elongated with a second longitudinal axis, and the second longitudinal axis may be substantially parallel to the first longitudinal axis. In an alternative embodiment, the longitudinal axis of the electrode may be substantially perpendicular to the first longitudinal axis.

The insert may include a first electrode holder and a second electrode holder. The insert may include at least one first spacer between the first electrode holder and the second electrode holder.

The insert may include an attachment device and a second spacer between the attachment device and the first electrode holder.

Each electrode may be arranged to be connected, at one end portion, to an electrical conductor.

In a second aspect, the invention relates more specifically to a method for injuring or killing undesired organisms in water in a channel, the method comprising the steps:

a) providing an apparatus as described in the above;

b) connecting one electrical conductor to the end portion of each of the electrodes;

c) positioning at least the electrodes of the apparatus internally in the channel, so that at least a portion of each electrode is submerged in the water in the channel;

d) attaching the apparatus;

e) connecting the electric electrodes to a direct-current supply, which may include a control unit, in such a way that the electrodes are connected in pairs with a positive pole and a negative pole in each pair; and

f) supplying a pulsed direct current to the electric electrodes.

In step f), the method may include changing the polarity between the pulses. In step f), the method may include using direct current at a voltage of between 12 V and 200 V. In step f), the method may include using direct current at amperage of between 50 A and 200 A.

In step f), the method may include using direct current at a voltage of between 12 V and 200 V combined with amperage of between 50 A and 200 A.

### BRIEF DESCRIPTION OF THE DRAWINGS

In what follows, an example of a preferred embodiment is described, which is visualized in the accompanying drawings in which:

FIG. 1 shows a side view of the apparatus according to the invention;

FIG. 2 shows a view, on a larger scale, of the apparatus seen from one end; and

FIG. 3 shows a perspective view, on a different scale, of an alternative design of the apparatus.

### DETAILED DESCRIPTION OF THE DRAWINGS

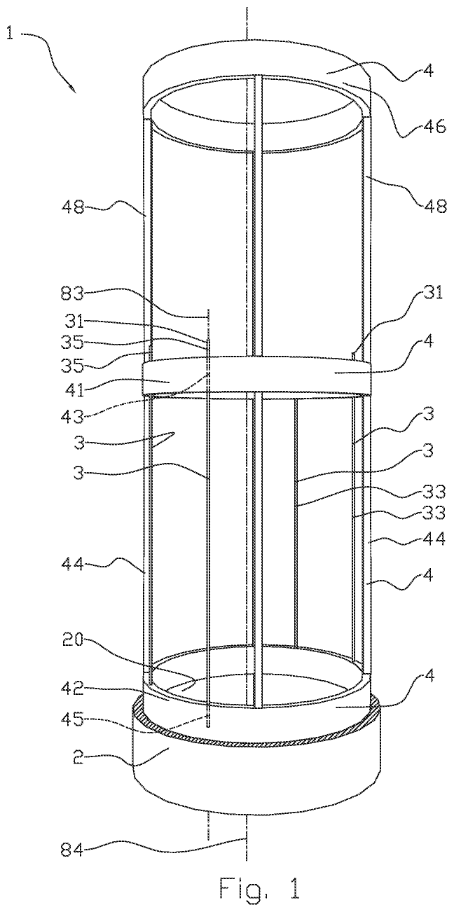

In the drawings, the reference numeral 1 indicates an apparatus which is arranged to be put into a channel 2 and taken out of the channel 2. The channel 2 is shown in FIG. 1 as a cylindrical pipe, but the channel 2 may also have other cross-sectional shapes, such as a square cross section. The apparatus 1 comprises a plurality of elongated electrodes 3 with longitudinal axes 83. The electrodes 3 are attached to an insert 4. The insert 4 forms a longitudinal axis 84. Each electrode 3 is connected to a power-supply unit (not shown) with an electrical conductor (not shown). The insert 4 consists of an electrically insulating material such as polyethene. The insert 4 is arranged to be attached internally in the channel 2.

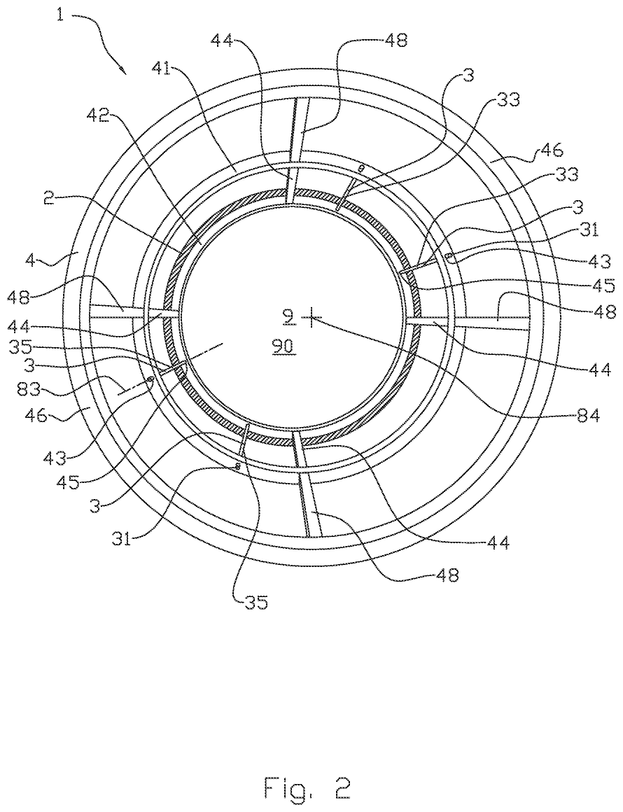

In the embodiment that is shown in FIGS. 1 and 2, the insert 4 is formed with a first electrode holder 41 and a second electrode holder 42. The first electrode holder 41 and the second electrode holder 42 are shown formed as short cylinders with an outer diameter that is somewhat smaller than an inner diameter of the cylindrical channel 2.

The first electrode holder 41 is shown provided with a plurality of through axial openings 43. The second electrode holder 42 is shown provided with a plurality of axial recesses 45. The electrode 3 has been passed through the opening 43 and into the recess 45. The insert 4 further includes a plurality of first spacers 44 which connect the first electrode holder 41 axially to the second electrode holder 42.

The insert 4 further includes an attachment device 46. In FIGS. 1 and 2, the attachment device 46 is shown formed as a short cylinder with an outer diameter that is somewhat smaller than the inner diameter of the cylindrical channel 2. A plurality of second spacers 48 connect the first electrode holder 41 axially to the attachment device 46. The attachment device 46 is arranged to be attachable to the inside 20 of the channel 2, for example with screws.

In the figures, the electrodes 3 are shown positioned diagonally. With reference to FIG. 2, a first electrode group 33 is positioned at about “one o'clock” and “two o'clock” and a second electrode group 35 is positioned at about “seven o'clock” and “eight o'clock”. In another embodiment, the electrodes 3 may be positioned with approximately equal peripheral spacing of the electrodes 3 (not shown).

Each electrode 3 has a free end portion 31 projecting axially from the first electrode holder 41. An electrical conductor (not shown) is connected to the free end portion 31. A heat-shrinkable tubing (not shown) may cover the connection between the electrode 3 and the electrical conductor to prevent corrosion on the electrical conductor.

The electrodes 3 of the first electrode group 33 are connected in parallel to the power-supply unit. The electrodes 3 of the second electrode group 35 are connected in parallel to the power-supply unit, and the second electrode group 35 has opposite polarity to the first electrode group 33.

In other embodiments, each electrode group 33, 35 may comprise more than two electrodes 3. The apparatus 1 may include more than two electrode groups 33, 35, like four or six electrode groups, and each of these electrode groups may comprise two or more than two electrodes 3.

The insert 4 may be formed in different ways from that shown in the figures. In an alternative embodiment (not shown), the insert 4 may be formed of an elongated central stem with a longitudinal axis 84. A star-shaped first electrode holder 41 has a number of arms directed radially out from the stem. A star-shaped second electrode holder 42 has a number of arms directed radially out from the stem. An electrode 3 is attached to a free end portion of an arm in the first electrode holder 41 and to a free end portion of an arm in the second electrode holder 42 so that the longitudinal axis 83 of the electrode 3 is substantially parallel to the longitudinal axis 84 of the insert 4. The attachment device 46 may also be star-shaped with a number of arms that may be equal to or different from the number of arms of the first electrode holder 41.

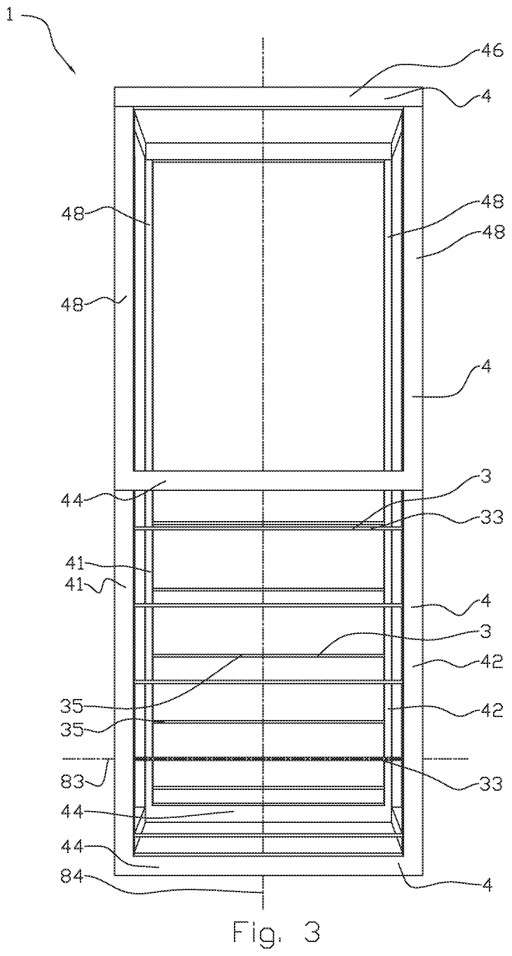

The insert 4 is shown in a further alternative embodiment in FIG. 3. The apparatus 1 includes a plurality of elongated electrodes 3 with longitudinal axes 83. The electrodes 3 are attached to the insert 4. The insert 4 forms a longitudinal axis 84. Each electrode 3 is connected to a power-supply unit (not shown) with an electrical conductor (not shown). The insert 4 is formed from an electrically insulating material such as polyethene. The insert 4 is arranged to be attachable internally in the channel 2 (not shown in FIG. 3).

The insert 4 is formed with a first electrode holder 41 and a second electrode holder 42. The insert 4 further includes a plurality of first spacers 44 connecting the first electrode holder 41 to the second electrode holder 42. A plurality of spacers 48 connect the first electrode holder 41 and the second electrode holder 42 axially to the attachment device 46. The attachment device 46 is arranged to be attachable to the inside 20 of the channel 2, for example with screws.

In this embodiment, the longitudinal axis 83 of the electrode 3 is oriented substantially perpendicularly to the longitudinal axis 84 of the insert 4. The first electrode group 33 is positioned on one side of the insert 4, and the second electrode group 35 is positioned on the opposite side of the insert 4.

The channel 2 may be formed of a pipe extending from a closed facility (not shown) and down a water column (not shown). At a lower portion, the pipe is provided with an inlet (not shown). In an upper portion, the pipe is formed with a T-connection (not shown), and one branch of the T-connection extends substantially horizontally into the closed facility. A pump (not shown) is positioned in the upper portion of the pipe and below the T-connection. The T-connection also has a maintenance branch (not shown) projecting substantially vertically up from the T-connection.

Depending on the positioning of the pump in the pipe, the apparatus 1 is positioned internally in the pipe either above the pump or below the pump. When the pump is below the apparatus 1, the electrodes 3 are positioned below the horizontal branch of the T-connection, whereas the attachment device 46 is attached internally in the maintenance branch. When the pump is above the apparatus 1, the pump is first lifted out of the pipe through the maintenance branch, the attachment device 46 is attached internally in the pipe below the T-connection and the pump is put back into the pipe.

The apparatus 1 is arranged to injure or kill undesired organisms in water 9 entering the channel 2. Undesired organisms may be crustacean parasites, like salmon lice, in sea water 90. In particular, salmon lice may be in one of the three pelagic stages, the nauplius stages I and II and the copepodid stage. After having passed the apparatus 1, the salmon louse will not be able to infect salmonids.

Pulsed current with changing polarity has turned out to be well suited for the purpose. Direct current at a voltage of between 12 V and 200 V, at amperage of between 50 A and 200 A and with pulses lasting for 2 ms with breaks of 15-20 ms between the pulses is an example of a suitable regime.

It should be noted that all the above-mentioned embodiments illustrate the invention, but do not limit it, and persons skilled in the art may construct many alternative embodiments without departing from the scope of the attached claims. In the claims, reference numbers in brackets are not to be regarded as restrictive.

The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1. An apparatus for injuring or killing undesired organisms in water in a channel, the apparatus comprising an insert configured to be releasably attached coupled to an inside of the channel, and a plurality of electrodes attached to the insert, wherein the insert is formed of an electrically insulating material and wherein the plurality of electrodes is connected to a power-supply unit.

2. The apparatus according to claim 1, wherein the insert is elongated with respect to a first longitudinal axis, wherein the electrode is elongated with respect to a second longitudinal axis, and wherein the second longitudinal axis is substantially parallel to the first longitudinal axis.

3. The apparatus according to claim 1, wherein the insert is elongated with respect to a first longitudinal axis, wherein the electrode is elongated with respect to a second longitudinal axis, and wherein the second longitudinal axis is substantially perpendicular to the first longitudinal axis.

4. The apparatus according to claim 1, wherein the insert comprises a first electrode holder and a second electrode holder.

5. The apparatus according claim 4, wherein the insert comprises at least one first spacer between the first electrode holder and the second electrode holder.

6. The apparatus according to claim 4, wherein the insert comprises an attachment device and a second spacer between the attachment device and the first electrode holder.

7. The apparatus according to claim 1, wherein an end portion of each electrode is configured to be connected to an electrical conductor.

8. A method for injuring or killing undesired organisms in water in a channel, the method comprising the steps of:
a) providing an apparatus comprising an insert configured to be releasably coupled to an inside of the channel, and a plurality of electrodes attached to the insert, wherein the insert is formed of an electrically insulating material and wherein the plurality of electrodes is connected to a power-supply unit;
b) connecting an electrical conductor to the end portion of each electrode in the plurality of electrodes;
c) positioning the plurality of electrodes in the channel so that at least a portion of each electrode is submerged in the water in the channel;
d) attaching the apparatus;
e) connecting the plurality of electric electrodes to a direct-current supply, which includes a control unit, so that the electrodes are connected in pairs with a positive pole and a negative pole in each pair; and
f) supplying a pulsed direct current to the electric electrodes.

9. The method according to claim 8, wherein the method, in step f), includes changing the polarity between pulses in the pulsed direct current.

10. The method according to claim 8, wherein the method, in step f), includes using a pulsed direct current at a voltage of between 12 V and 200 V.

11. The method according to claim 8, wherein the method, in step f), includes using a direct current at amperage of between 50 A and 200 A.

12. The apparatus according to claim 2, wherein an end portion of each electrode is configured to be connected to an electrical conductor.

13. The apparatus according to claim 3, wherein an end portion of each electrode is configured to be connected to an electrical conductor.

14. The apparatus according to claim 4, wherein an end portion of each electrode is configured to be connected to an electrical conductor.

15. The apparatus according to claim 5, wherein an end portion of each electrode is configured to be connected to an electrical conductor.

16. The apparatus according to claim 6, wherein an end portion of each electrode is configured to be connected to an electrical conductor.
